(19) United States
(12) Patent Application Publication
(10) Pub. No.: US 2008/0231475 A1
(43) Pub. Date: Sep. 25, 2008

(54) System and method for displaying real-time speed limit conditions on a mobile direction device

(76) Inventors: Asael Ramos, Charlotte, NC (US); Key Ramos, Charlotte, NC (US)

Correspondence Address: Steven Thrasher, 391 Sandhill Dr., Richardson, TX, 75080, US

(21) Appl. No.: 11/728,168

(22) Filed: Mar. 24, 2007

(51) Int. Cl. G08G 1/123

(52) U.S. Cl. 340/995.27

(57) ABSTRACT

The invention is system and method for displaying real-time speed limit information on the display of a mobile direction device. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### TECHNICAL FIELD OF THE INVENTION

The invention relates to the field of mobile direction devices.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Mobile direction devices, such as the StreetPilot® from Garmin® have received wide-spread acceptance by drivers who need to know how to get somewhere. Typically, these devices provide a map of a display, a listing of roads and the direction of turns, and a voice that audibly delivers the instructions to the driver so that the driver can keep their eyes on the road. Additionally, mobile devices, such as cell phones, smart phones, pagers, and personal digital assistants, are becoming increasingly important personal management devices. Many of these devices provide calendar, tasks, contacts, as well as location finding and assistance with directions, and are thus encompassed within the definition of a mobile direction device. Mobile direction devices include the dash-mounted automobile devices dedicated to navigation, and general automobile display devices as well. Mobile direction devices are typically pre-loaded with map information, and may also include information regarding the location of restaurants, hotels, gas stations, and the like. Sometimes, this information is loaded separately to the device through an internet download or separate memory device. However, driving in an unfamiliar location has hazards other than getting lost. For example, experienced drivers are sometimes shocked when in an unfamiliar location or when driving an unfamiliar car to discover that they have exceeded the local speed limit and receive a traffic citation. The disclosed invention also solves this and related problems.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is a block-schematic of a mobile direction device system.

FIG. 2 shows a mobile direction device display.

FIG. 3 illustrates a speed-limit algorithm.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in § 112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### DESCRIPTION OF THE DRAWINGS

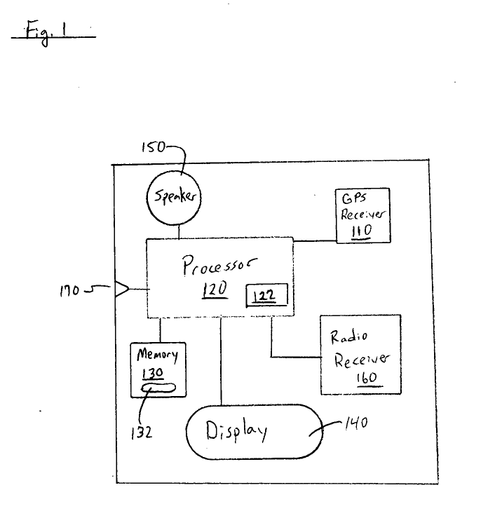

FIG. 1 is a block-schematic of a mobile direction device system. The system comprises a location identification system 110 that identifies a location of the location identification system. A preferred location identification system 110 is a global positioning system (GPS), however, it is understood that alternative location identification systems are available and may be incorporated into the system, such as a mobile-phone tower triangulation system, pager tower triangulation system, or the like. The location identification system 110 is coupled to a processor 120, which may be a general computing processor or a specific processing device. The processor preferably includes a clock 122 that monitors time. However, it is understood that a clock may be located off the processor to achieve equivalent functionality. The system includes memory 130 coupled to the processor 120. The memory stores a software program 132 that associates the location with a speed limit at the location, and may also associate the time, location, and/or direction of travel with a speed limit. In addition, the memory also stores street information, and may also store information regarding the location of specific destinations, such as restaurants, airports, gas stations, hotels, courts, and the like. Of course, memory 130 may in an equivalent embodiment be co-located within the processor 120. Further, it is desirable to include an input/output (I/O) port 170 that allows the system to communicate with a separate system for updating or downloading data and/or software stored in memory 130.

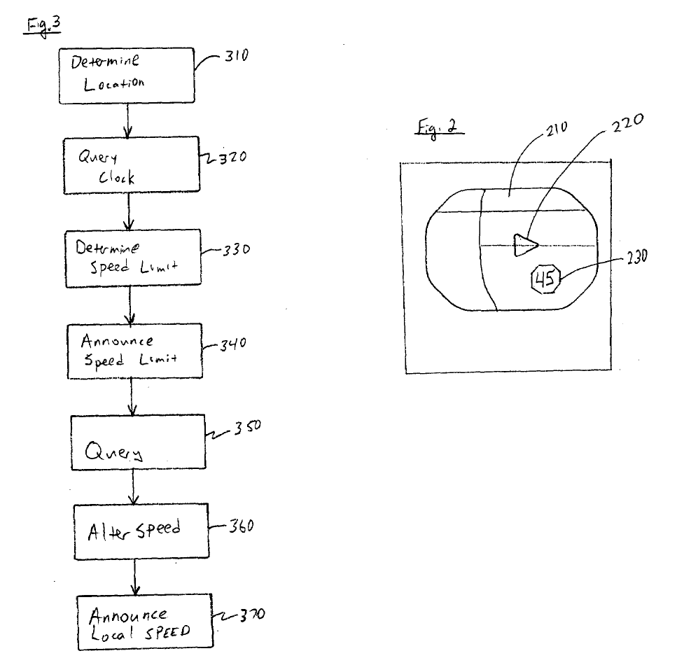

The system also provides at least one communication device that communicates the speed limit to a person. One communication device could be an audio speaker 150, while another communication device could be a display device 140; for example, FIG. 2 shows a mobile direction device display. The mobile direction display device includes a screen 210 that provides a map of the general area containing the system, where the system is indicated in FIG. 2 as an elongated triangle 220. The screen 210 graphically displays the speed limit 230, here inside an octagon so that the speed limit stands out against the background map. Of course, other icons and display devices can be used to draw attention to the speed limit. For example, the speed limit may flash continuously, flash when the speed limit changes, or flash if the speed limit is exceeded. Similarly, a polygon that surrounds the speed limit may change as there is a change in speed, for different speeds, or if the speed is exceeded, or if the speed is exceeded by a certain amount—such as exceeded by ten miles an hour. Alternatively, different sounds (including vocal indications) may announce a change in speed, or if the speed is being exceed, or being exceeded by a certain amount. The speed limit may also be displayed as miles per hour, or kilometers per hours, per local regulations or selected user presence.

FIG. 3 illustrates a speed-limit algorithm/method. The method begins by determining the location of a mobile direction device in a determine location act 310. This can be accomplished via any device discussed above or equivalent. Next, the algorithm proceeds to a query clock act 320 in which the local time is determined via a clock. Then, in a determine speed limit act 330, the algorithm proceeds to associate the location and time with a speed limit stored in a memory so that this information can be announced so that a driver can receive the information by activating a communication device to announce the speed limit via either an auditory or visual communication device in an announce speed limit act 340.

Local traffic conditions determined by such events as construction or an accident could impede traffic flow and result in the setting of a temporary speed limit. Accordingly, the algorithm could further comprise a query act 350 whereby a radio receiver that receives locally-broadcast traffic information is queried. Sometime, the locally-broadcast traffic information comprises a second speed limit information for a road being traveled that is different from the speed limit. Thus, in an alter speed act 360 the temporary speed limit is received and in an announce altered speed act the temporary (second) speed limit is announced, and the announcement of the “regular” speed limit is suppressed before it can be announced in an announce local speed act 370.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A system, comprising:
a location identification system that identifies a location of the location identification system;
the location identification system coupled to a processor;
a memory coupled to the processor, the memory storing therein a software program that associates the location with a speed limit at the location; and
a communication device that communicates the speed limit to a person.

2. The system of claim 1 wherein the location identification system is a Global Positioning System (GPS) receiver.

3. The system of claim 1 wherein the communication device is an audio speaker.

4. The system of claim 1 wherein the communication device is a display device.

5. The system of claim 1 wherein the processor comprises a clock that monitors time.

6. The system of claim 5 wherein the software associates the location and time with the speed limit.

7. A method, comprising:
determining the location of a mobile direction device;
querying a clock to determine time;
associating the location and time with a speed limit stored in a memory; and
activating a communication device to announce the speed limit.

8. The method of claim 7 further comprising querying a radio receiver that receives locally-broadcast traffic information.

9. The method of claim 8 wherein the locally-broadcast traffic information comprises a second speed limit information for a road being traveled that is different from the speed limit.

10. The method of claim 9 wherein the act of activating a communication device is altered to announce the second speed limit instead of the speed limit.
